(19) United States
(12) Patent Application Publication
(10) Pub. No.: US 2004/0187256 A1
(43) Pub. Date: Sep. 30, 2004

(54) Handle structure for tool boxes

(76) Inventor: Pei-Ling Lee, Taichung City (TW)

Correspondence Address: CHARLES E. BAXLEY, ESQUIRE, 59 John Street, Fifth Floor, New York, NY, 10038, US

(21) Appl. No.: 10/402,668

(22) Filed: Mar. 28, 2003

(51) Int. Cl. E05B 1/00

(52) U.S. Cl. 16/114.1

(57) ABSTRACT

A tool box includes a base and a cover which is pivotably connected to a side of the base, and at least one of the base and the cover has receiving members defined in an edge and an outer surface thereof. A handle includes a handle portion and a decoration portion which is connected to the handle portion and matched with a profile of the at least one of the base and the cover. A plurality of engaging members are connected to the handle portion and the decoration portion. The engaging members are engaged with the receiving members.

### FIELD OF THE INVENTION

The present invention relates to a handle that is snapped onto the base and the cover respectively so as to provide a better appearance.

### BACKGROUND OF THE INVENTION

A conventional tool box 1 is shown in FIG. 1 and generally includes a base 10 and a cover 11 which is pivotably connected to a side of the base 10, and two locking members 12 are connected to the cover 11 so as to engage with the base 10 and lock the cover 11 on the base 10. A handle 13 is pivotably connected between two handle frames 14 on the base 10. The handle 13 is nothing but a function piece when designing the tool box so that the designers pay less attention on the handles.

The present invention intends to provide a handle structure that includes a handle portion and a decoration portion, both of which are connected to the base and the cover respectively. The handle brings a brand new appearance of change for the tool boxes.

### SUMMARY OF THE INVENTION

In accordance with one aspect of the present invention, there is provided a tool box which comprises a base and a cover which is pivotably connected to a side of the base. At least one of the base and the cover has receiving members defined in an edge and an outer surface thereof. A handle includes a handle portion and a decoration portion which is connected to the handle portion and matched with a profile of the at least one of the base and the cover. A plurality of engaging members are connected to the handle portion and the decoration portion. The engaging members are engaged with the receiving members.

The primary object of the present invention is to provide a handle that has a decoration portion and can be connected to the base or the cover by snapping means or rivets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional tool box;

FIG. 2 is an exploded view to show the handle and the tool box of the present invention;

FIG. 3 is a cross sectional view to show the handle is snapped onto the cover of the tool box;

FIG. 4 is a cross sectional view to show the tool box in a closed status;

FIG. 5 show another embodiment of the engaging members and the receiving members, and

FIG. 6 is an exploded view to show another embodiment of the present invention.

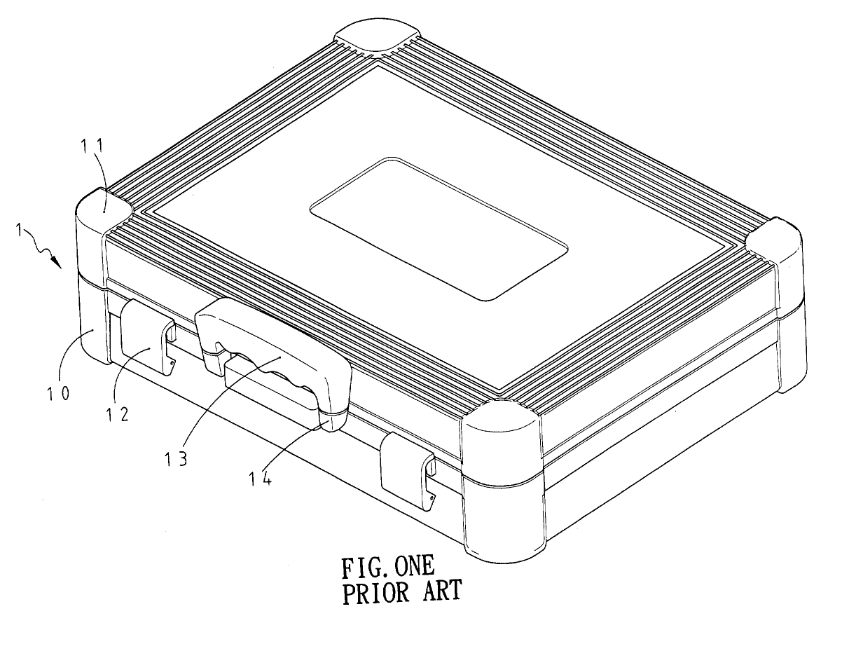

### DETAILED DESCRIPTION OF THE PREFERRED EMBODIMENT

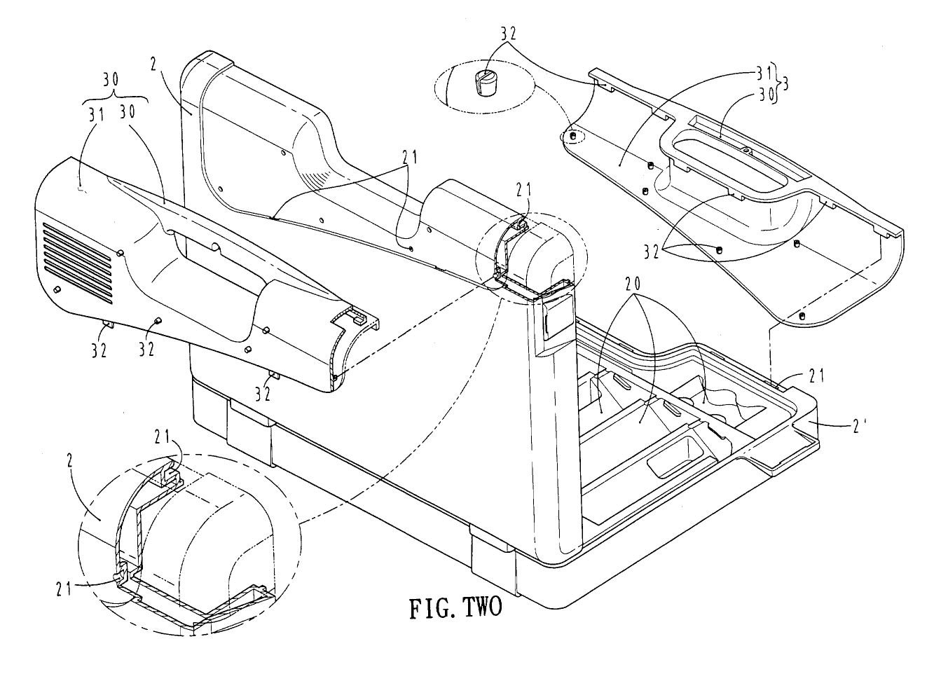

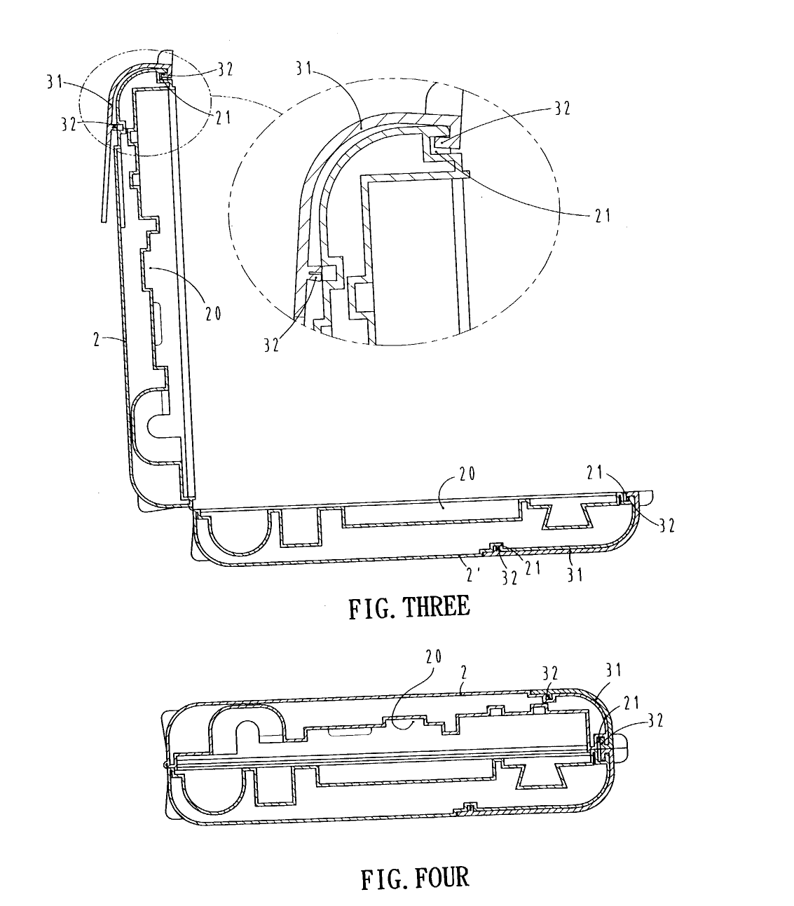

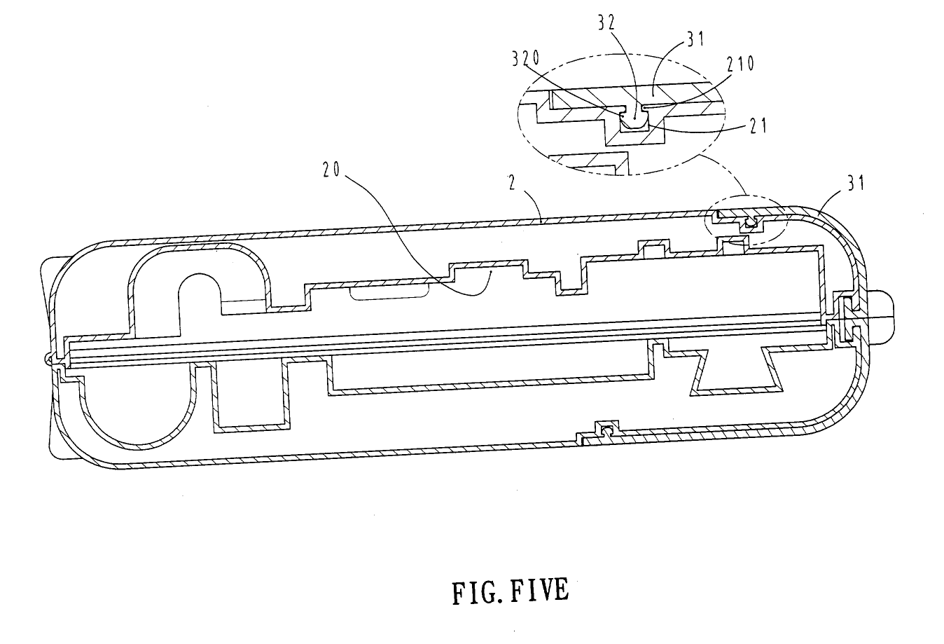

Referring to FIGS. 2 to 4, the tool box of the present invention comprises a base 20 and a cover 2 which is pivotably connected to a side of the base 2′. Each of the base 2′ and the cover 2 has receiving members 21 defined in an edge and an outer surface thereof, and the receiving members 21 can be notches. Each of the base 2′ and the cover 2 has a plurality of recessed areas 20 for receiving tools or accessories therein.

A handle 3 includes a handle portion 30 and a decoration portion 31 which is integral with the handle portion 30 and matched with a profile or curvature of the base 2′ and the cover 2. A plurality of engaging members 32 such as protrusions are connected to the handle portion 30 and the decoration portion 31. The engaging members 32 of the handle 3 are engaged with the receiving members 21 of the base 2′ and the cover 2. Therefore, the handle 3 may have a wide range of decorative feature in shapes and sizes so as to make the tool box to be more commercially attractive.

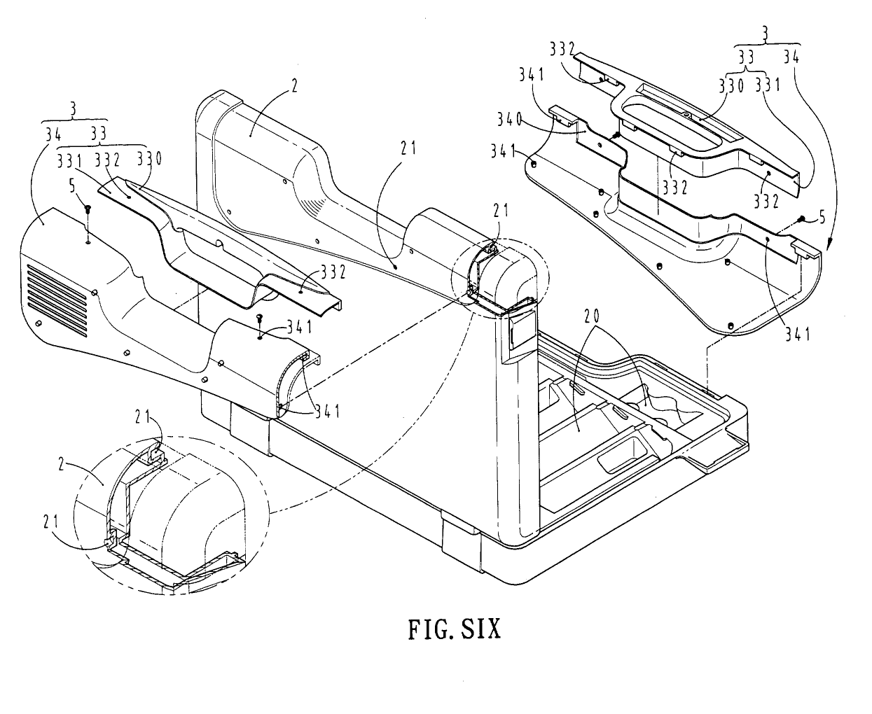

Referring to FIG. 5, the engaging members 32 each may have an enlarged head 320 and each of the notches may have a reduced entry 210 so that the enlarged head 320 is force-fitted into the notch via the reduced entry 210.

FIG. 6 shows another embodiment of the present invention, wherein the handle 3 includes a handle portion 33 which is composed of a grasp portion 330 and two extensions 331 and a decoration portion 34. The handle portion 33 has first connection holes 332 and the decoration portion 34 has second connection holes 341. Rivets 5 extend through the aligned first connection holes 332 and the second connection holes 341 to connect the grasp portion 330 and the decoration portion 34. The decoration portion 34 has recesses 340 defined in an inside thereof and the extensions 331 are engaged with the recesses 340.

While we have shown and described the embodiment in accordance with the present invention, it should be clear to those skilled in the art that further embodiments may be made without departing from the scope of the present invention.

What is claimed is:

1. A tool box comprising:
a base and a cover which is pivotably connected to a side of the base;
at least one of the base and the cover having receiving members defined in an edge and an outer surface thereof, and
a handle including a handle portion and a decoration portion which is connected to the handle portion and matched with a profile of the at least one of the base and the cover, a plurality of engaging members connected to the handle portion and the decoration portion, the engaging members engaged with the receiving members.

2. The tool box as claimed in claim 1, wherein the handle portion having first connection holes and the decoration portion having second connection holes, rivets extending through the aligned first connection holes and the second connection holes.

3. The tool box as claimed in claim 2, wherein the decoration portion has recesses defined in an inside thereof and the handle portion has extensions which are engaged with the recesses.

4. The toot box as claimed in claim 1, wherein the engaging members are protrusions and the receiving members are notches.

5. The tool box as claimed in claim 4, wherein the engaging members each have an enlarged head and each of the notches has a reduced entry so that the enlarged head is force-fitted into the notch via the reduced entry.
